(19) United States
(12) Patent Application Publication
(10) Pub. No.: US 2026/0161277 A1
(43) Pub. Date: Jun. 11, 2026

(54) ELECTRONIC DEVICE, METHOD, AND COMPUTER-READABLE STORAGE MEDIUM FOR DISPLAYING EXPANDED WIDGET

(71) Applicant: SAMSUNG ELECTRONICS CO., LTD., Suwon-si (KR)

(72) Inventors: Jinhyun JANG, Suwon-si (KR); Kyungdeok KIM, Suwon-si (KR); Yongkwon KIM, Suwon-si (KR); Sangheon KIM, Suwon-si (KR); Jeongseob KIM, Suwon-si (KR)

(21) Appl. No.: 19/179,634

(22) Filed: Apr. 15, 2025

Related U.S. Application Data
(63) Continuation of application No. PCT/KR2025/003887, filed on Mar. 26, 2025.

(30) Foreign Application Priority Data
Jul. 4, 2024 (KR) 10-2024-0088544
Jul. 25, 2024 (KR) 10-2024-0098949
Sep. 10, 2024 (KR) 10-2024-0123013

(51) Int. Cl. G06F 3/04845; G06F 3/04842; G06F 3/04886

(52) U.S. Cl. CPC G06F 3/04845; G06F 3/04842; G06F 3/04886

(57) ABSTRACT

An electronic device includes memory, including one or more storage mediums, storing instructions, a display, and at least one processor including processing circuitry, and the instructions, when executed by the at least one processor individually or collectively, cause the electronic device to display, through the display, a plurality of widgets, based on an event, identify a changed display size of a widget selected among the plurality of widgets, identify a first area corresponding to a first blank area in the display, if the selected widget with the changed display size is able to be displayed in the first area, display the selected widget in a second area including the first area, and if the selected widget is not able to be displayed with the changed display size in the first area, display the selected widget with the changed display size in a third area caused by reducing the remaining widgets.

### CROSS-REFERENCE TO RELATED APPLICATIONS

This application is a continuation of International Application No. PCT/KR2025/003887 designating the United States, filed on Mar. 26, 2025, in the Korean Intellectual Property Receiving Office and claiming priority to Korean Patent Application Nos. 10-2024-0088544, filed on Jul. 4, 2024, and 10-2024-0098949, filed on Jul. 25, 2024 and 10-2024-0123013, filed on Sep. 10, 2024, in the Korean Intellectual Property Office, the disclosures of each of which are incorporated by reference herein in their entireties.

### BACKGROUND

### Technical Field

The present disclosure relates to an electronic device, a method, and a computer-readable storage medium for displaying an expanded widget.

### Background Art

A widget may be a graphic user interface (GUI) for controlling a partial function and/or displaying information, of an application related to the widget. For example, the widget may be an information widget or a management widget. For example, the widget may be an integrated widget that mixes the information widget and the management widget. For example, the widget may be referred to as a mini-application for an application related to the widget.

The above-described information may be provided as a related art for the purpose of helping to understand the present disclosure. No claim or determination is raised as to whether any of the above-described information may be applied as a prior art related to the present disclosure.

### SUMMARY

An electronic device is described. The electronic device may comprise memory, comprising one or more storage mediums, storing instructions, a display, and at least one processor comprising processing circuitry. The instructions, when executed by the at least one processor individually or collectively, may cause the electronic device to display, through the display, a plurality of widgets. The instructions, when executed by the at least one processor individually or collectively, may cause the electronic device to, based on an external input or an event, select a widget among the plurality of widgets. The instructions, when executed by the at least one processor individually or collectively, may cause the electronic device to identify a changed display size for expanding a display size of the selected widget. The instructions, when executed by the at least one processor individually or collectively, may cause the electronic device to, based on the changed display size, identify a first area corresponding to a first blank area in the display for displaying the selected widget. The instructions, when executed by the at least one processor individually or collectively, may cause the electronic device to, if the selected widget with the changed display size is able to be displayed in the first area, display the selected widget in a second area including the first area. The instructions, when executed by the at least one processor individually or collectively, may cause the electronic device to, if the selected widget with the changed display size is not able to be displayed in the first area, display remaining widgets excluding the selected widget among the plurality of widgets by reducing a size of the remaining widgets, and display the selected widget with the changed display size in a third area corresponding to a second blank area caused by reducing the remaining widgets as the changed display size.

A method is described. The method may be executed in an electronic device comprising a display. The method may comprise displaying, through the display, a plurality of widgets. The method may comprise, based on an external input or an event, selecting a widget among the plurality of widgets. The method may comprise identifying a display size changed for expanding a display size of the selected widget. The method may comprise, based on the changed display size, identifying a first area corresponding to a blank area in the display for displaying the selected widget. The method may comprise, if the selected widget with the changed display size is able to be displayed in the first area, displaying the selected widget in a second area including the first area. The method may comprise, if the selected widget with the changed display size is not able to be displayed in the first area, displaying remaining widgets excluding the selected widget among the plurality of widgets by reducing a size of the remaining widgets, and displaying the selected widget with the changed display size in a third area corresponding to a second blank area caused by reducing the remaining widgets.

A non-transitory computer readable storage medium is described. The non-transitory computer readable storage medium may store one or more programs. The one or more programs may comprise instructions to, when executed by an electronic device comprising a display, cause the electronic device to display, through the display, a plurality of widgets. The one or more programs may comprise instructions to, when executed by the electronic device, cause the electronic device to, based on an external input or an event, select a widget among the plurality of widgets. The one or more programs may comprise instructions to, when executed by the electronic device, cause the electronic device to identify a changed display size for expanding a display size of the selected widget. The one or more programs may comprise instructions to, when executed by the electronic device, cause the electronic device to, based on the changed display size, identify a first area corresponding to a first blank area in the display for displaying the selected widget. The one or more programs may comprise instructions to, when executed by the electronic device, cause the electronic device to, if the selected widget with the changed display size is able to be displayed in the first area, display the selected widget in a second area including the first area. The one or more programs may comprise instructions to, when executed by the electronic device, cause the electronic device to, if the selected widget with the changed display size is not able to be displayed in the first area as the changed display size, display remaining widgets excluding the selected widget among the plurality of widgets by reducing a size of the remaining widgets, and display the selected widget with the changed display size in a third area corresponding to a second blank area caused by reducing the remaining widgets.

### BRIEF DESCRIPTION OF THE DRAWINGS

FIG. 1 illustrates an example of a displayed screen based on an input to a widget.

FIG. 2 is a simplified block diagram of an exemplary electronic device.

FIG. 3 is a flowchart illustrating exemplary operations of an electronic device for expanding a size of a widget.

FIGS. 4A and 4B illustrate an example of an input for expanding a size of a widget.

FIG. 5 illustrates an example of a widget having an expanded size displayed while maintaining an arrangement of one or more remaining widgets.

FIG. 6 is a flowchart illustrating exemplary operations of an electronic device for expanding a size of a widget by changing an arrangement of one or more remaining widgets.

FIG. 7 illustrates an example of a widget having an expanded size displayed in a blank area caused by changing an arrangement of one or more remaining widgets.

FIG. 8 is a flowchart illustrating exemplary operations of an electronic device for expanding a size of a widget according to whether to reduce one or more remaining widgets.

FIG. 9 illustrates an example of a widget having an expanded size displayed in a blank area caused by reducing one or more remaining widgets.

FIG. 10 illustrates an example of a widget having an expanded size displayed by overlapping on one or more remaining widgets.

FIG. 11A illustrates an example of a widget displayed based on an input to an object corresponding to a software application.

FIG. 11B illustrates an example of a widget displayed based on an input to a folder including an object corresponding to a software application.

FIGS. 12A, 12B, and 12C illustrate an example of a method of expanding a size of a widget according to a type of an electronic device.

FIG. 13 illustrates an example of configurations of at least one processor.

FIG. 14 is a block diagram of an electronic device in a network environment according to various embodiments.

### DETAILED DESCRIPTION

Hereinafter, an embodiment of the present disclosure will be described in detail with reference to the drawing so that those having ordinal knowledge in the art to which the present disclosure belongs may easily implement the present disclosure. However, the present disclosure may be implemented in several different forms and is not limited to an embodiment described herein. In connection with the description of the drawing, the same or similar reference numeral may be used for the same or similar component. In addition, in the drawing and the related description, the description of a well-known function and configuration may be omitted for clarity and brevity.

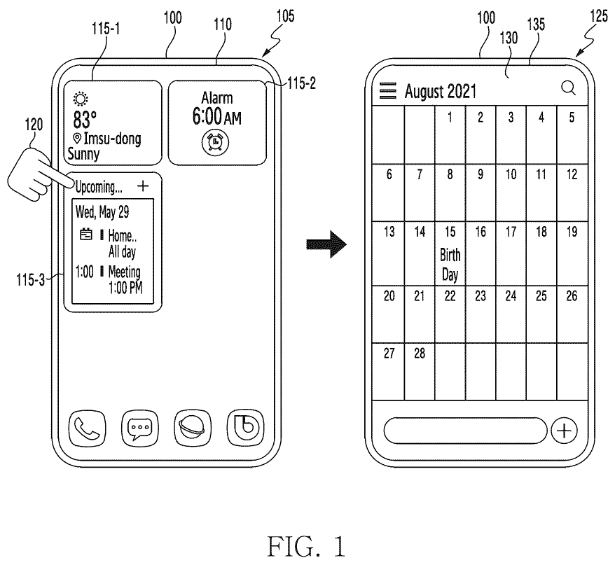

FIG. 1 Illustrates an Example of a Screen Displayed Based on an Input to a Widget.

Referring to FIG. 1, an electronic device 100 may be described as a device available for displaying widgets 115-1, 115-2, and 115-3. For example, the electronic device 100 may be one of various types of mobile devices such as smartphones (e.g., a bar-type smartphone, a foldable type smartphone, or a rollable type smartphone), a tablet, a wearable device, a cellular phone, a laptop, and/or other similar computing devices having various form factors that include circuits (or circuitry) for providing an operation of displaying widgets.

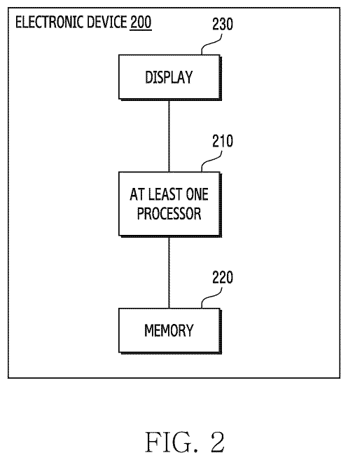

For example, a state 105 may be described as a state in which an input to the widget 115-3 is received. For example, the electronic device 100 may include a display (e.g., a display 230 of FIG. 2). For example, in the state 105, the electronic device 100 may display a screen 110 through the display. For example, the electronic device 100 may display the widgets 115-1, 115-2, and 115-3 on the screen 110. For example, the screen 110 may be defined as an activity, and each of the widgets may be defined as a view. For example, the view, which is a basic element (e.g., a button, an edit box, and/or a check box) that configures a user interface, may be described as a component that configures the screen 110. For example, the activity may configure and manage a user interface.

For example, the widgets 115-1, 115-2, and 115-3 may display an information element (e.g., current weather or alarm time) provided by a software application related to a widget. For example, the widgets 115-1, 115-2, and 115-3 may display a functional element (e.g., adding a schedule, or setting an alarm) provided by the application related to the widget. For example, the electronic device 100 may control a partial function of the software application related to the widget in response to a selection for the functional element provided by the widget. For example, the widget may be referred to as a mini-application for the application related to the widget. The widgets 115-1, 115-2, and 115-3 can generally be referred to as widgets 115.

For example, the electronic device 100 may receive an input 120 to one widget 115-3 among the widgets 115-1, 115-2, and 115-3. For example, the input 120 may include a touch input to the widget 115-3. For example, based on receiving the input 120, the electronic device 100 may switch from the state 105 to a state 125.

For example, in the state 125, based on receiving the input 120, the electronic device 100 may execute a software application 130 related to the widget 115-3, or return the software application 130 related to the widget 115-3 in a background to a foreground. For example, the electronic device 100 may display a screen 135 provided from the software application 130 related to the widget 115-3 through the display. For example, by displaying the screen 135 provided by the software application 130 related to the widget 115-3 in a full screen, the remaining widgets 115-1 and 115-2 may not be displayed on the screen. For example, as the remaining widgets 115-1 and 115-2 are not displayed on the screen, an information element (e.g., current weather or alarm time) provided by a software application related to the remaining widgets 115-1 and 115-2 may not be displayed.

For example, a user may feel uncomfortable (or fail to have the best user experience) by not being provided with the information element (e.g., the current weather or the alarm time) of the software application related to the remaining widgets 115-1 and 115-2. For example, based on the input 120, a method may be required to resolve the discomfort of a user caused by displaying the screen 135 provided to the software application 130 related to the widget 115-3 in the full screen.

For example, in order to resolve this discomfort or improve the user experience on the electronic device 100, the electronic device 100 may maintain displaying the information element (e.g., the current weather or the alarm time) provided by the software application related to the remaining widgets 115-1 and 115-2 by refraining from displaying the screen 135 provided to the software application 130 related to the widget 115-3 in the full screen based on the input 120. For example, in order to resolve this discomfort or improve the user experience on the electronic device 100, a widget having a size expanded from the widget 115-3 may be used.

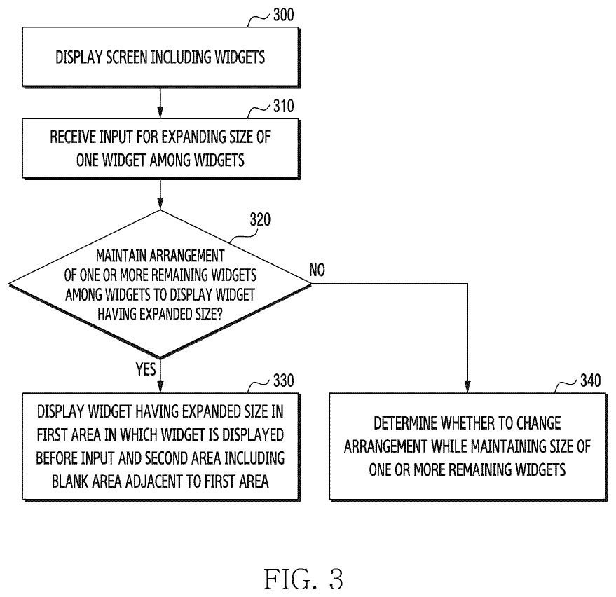

The electronic device 100 may execute operations to be exemplified in the description of FIGS. 3 to 13 to display the widget having the size expanded from the widget 115-3. For example, the initial/original size of the widget 115-3 is expanded to a larger size. In one or more embodiments, the initial/original size of the widget 115-3 can be expanded to a larger size while still displaying the information element of at least one or more remaining widgets, thereby improving the user experience on the electronic device 100. The electronic device 100 may include components for executing the operations. The components may be exemplified in the description of FIG. 2.

FIG. 2 Is a Simplified Block Diagram of an Exemplary Electronic Device.

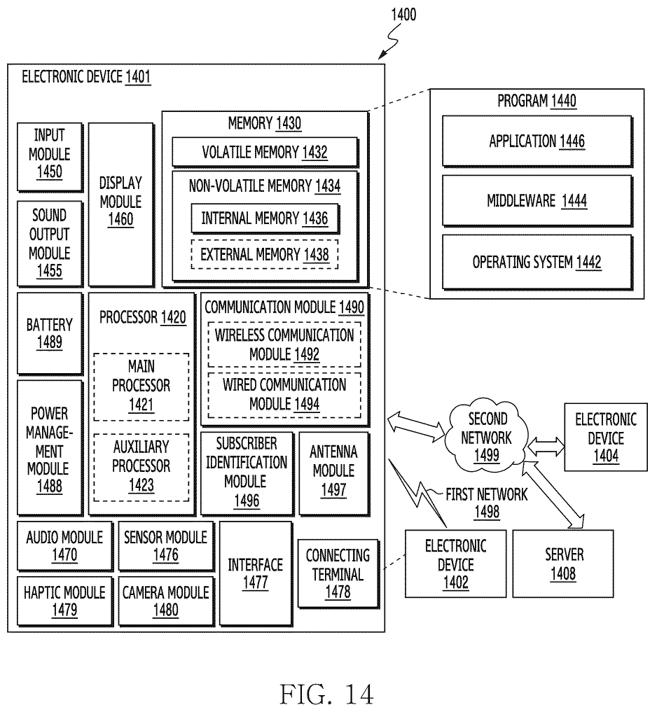

Referring to FIG. 2, an electronic device 200 may be one of various types of mobile devices such as smartphones (e.g., a bar-type smartphones a foldable type smartphone, or a rollable type smartphone), a tablet, a wearable device, a cellular phone, a laptop, and/or other similar computing devices having various form factors. For example, the electronic device 200 may include the electronic device 100 of FIG. 1 or may correspond to the electronic device 100 of FIG. 1. For example, the electronic device 200 may include at least a portion of an electronic device 1401 of FIG. 14, or may correspond to at least a portion of the electronic device 1401 of FIG. 14. For example, the electronic device 200 may include at least one processor 210, memory 220, and a display 230.

The at least one processor 210 may include processing circuitry. For example, the at least one processor 210 may include a central processing unit (CPU) (e.g., including the processing circuitry). For example, the at least one processor 210 may include a graphic processing unit (GPU) (e.g., including the processing circuitry) and/or a neural processing unit (NPU) (e.g., including the processing circuitry). For example, the at least one processor 210 may be described as an application processor. For example, the at least one processor 210 may be configured to control the memory 220 and the display 230. The at least one processor 210 may be configured to execute instructions stored in the memory 220 individually or collectively to cause the electronic device 200 to perform at least a portion of the operations exemplified in the description of FIG. 1. The at least one processor 210 may be configured to execute the instructions stored in the memory 220 to cause the electronic device 200 to perform at least a portion of operations exemplified in the description of FIGS. 3 to 13.

The memory 220 may include one or more storage mediums. For example, the memory 220 may store various data used by at least one component (e.g., the at least one processor 210 and/or the display 230) of the electronic device 200. For example, the data may include input data or output data for software and a command associated therewith. The memory 220 may include volatile memory or non-volatile memory.

The display 230 may include a touch sensor set to detect a touch, or a pressure sensor set to measure intensity of a force generated by the touch. For example, the display 230 may be configured to display a screen. For example, the display 230 may be configured to display widgets on the screen. For example, the display 230 may be configured to receive an input to the widgets.

The electronic device 200 exemplified in the description of FIG. 2 may execute at least a portion of the operations exemplified in the description of FIGS. 3 to 13. For example, the operations exemplified in the description of FIGS. 3 to 13 may be caused by (or in) the electronic device 200 according to a control of the at least one processor 210.

FIG. 3 is a flowchart illustrating exemplary operations of an electronic device for expanding a size of a widget.

Referring to FIG. 3, in an operation 300, at least one processor 210 may display a screen (e.g., the screen 110 of FIG. 1) including widgets (e.g., the widgets 115 of FIG. 1) through a display 230. For example, the at least one processor 210 may perform the following operations (e.g., operations 310 to 340) while displaying the screen including the widgets.

In an operation 310, the at least one processor 210 may receive an input for expanding a size of a widget (e.g., the widget 115-3 of FIG. 1) among the widgets. For example, the input for expanding the size of one widget among the widgets may be described as an external input.

According to another embodiment, the at least one processor 210 may detect an event for expanding the size of the one widget. For example, the event for expanding the size of the widget may include a notification event generated by a software application related to the widget. For example, the event for expanding the size of the widget may be detected by the software application related to the widget receiving information through network polling and/or a push notification. For example, in the widget, an information element provided by the software application related to the widget may be updated or added based on the event for expanding the size of the widget. As a non-limiting example, an event for expanding a size of a widget for weather may include a notification (e.g., a notification for rainfall and/or a notification for an end of a rainfall) event generated by a software application for the weather. An event for expanding a size of a widget for news may include a notification (e.g., a notification for breaking news) event generated by a software application for news. However, examples of events are not limited thereto.

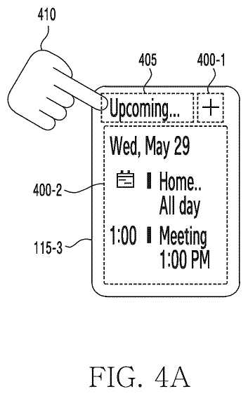

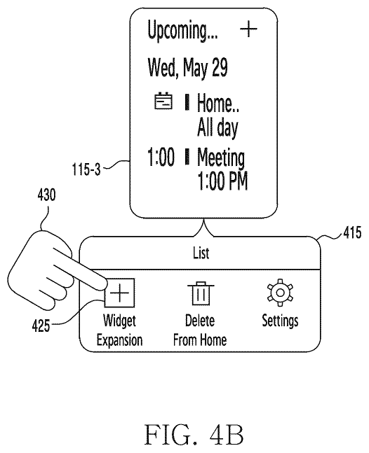

The input for expanding the size of the one widget among the widgets is exemplified in the description of FIGS. 4A and 4B.

FIGS. 4A and 4B illustrate an example of an input for expanding a size of a widget.

Referring to FIG. 4A, a widget 115-3 may display a functional element (e.g., adding a schedule) provided by an application related to the widget 115-3. For example, at least one processor 210 may control a partial function of a software application related to the widget 115-3 in response to a selection for the functional element provided by the widget 115-3. For example, the widget 115-3 may include areas 400-1 and 400-2 corresponding to the functional element. For example, the at least one processor 210 may control a partial function (e.g., a schedule addition function) of the software application related to the widget 115-3 based on a touch input to the areas 400-1 and 400-2 corresponding to the functional element. For example, the areas 400-1 and 400-2 of the widget 115-3 may be described as executable areas of the widget 115-3.

For example, the widget 115-3 may include an area 405 other than the areas 400-1 and 400-2 corresponding to the functional element. For example, the area 405 other than the areas 400-1 and 400-2 corresponding to the functional element may include an area corresponding to an information element. For example, the area 405 of the widget 115-3 may be described as an area other than the executable area of the widget 115-3. For example, the at least one processor 210 may receive a touch input 410 to the area 405. For example, the at least one processor 210 may receive the touch input 410 through a display 230 (e.g., a touch screen). For example, the touch input 410 may include a single tap input having a contact point on the area 405. For example, the touch input 410 to the area 405 may be described as an input for expanding a size of the widget 115-3.

According to another embodiment, the input for expanding the size of the widget 115-3 may include a touch input having a contact point on the widget 115-3 in which the touch input is distinct from the single tap input for the widget 115-3. As a non-limiting example, the input for expanding the size of the widget 115-3 may include a double tap input having a contact point on the widget 115-3, a long press input having a contact point on the widget 115-3 during time more than or equal to a reference time, and/or a drag input from the widget 115-3 in a direction in which the size of the widget 115-3 is expanded. However, the input for expanding the size of the widget 115-3 is not limited thereto.

Referring to FIG. 4B, the at least one processor 210 may display a pop-up menu 415 associated with the widget 115-3 through the display 230 based on a touch input (e.g., the double tap input to the widget 115-3 and/or the long press input to the widget 115-3) that is distinct from the single tap input to the widget 115-3. For example, the pop-up-menu 415 may include executable objects corresponding to functions related to the widget 115-3.

For example, the at least one processor 210 may receive an input 430 to an executable object 425 for expanding the size of the widget 115-3 among the executable objects of the pop-up-menu 415. For example, the executable object 425 for expanding the size of the widget 115-3 may include an icon and/or a text indicating expanding the size of the widget 115-3. For example, the input 430 may include a touch input having a contact point on the executable object 425. For example, the at least one processor 210 may receive the input 430 through the display 230 (e.g., the touch screen). For example, the input 430 to the executable object 425 may be described as an input for expanding the size of the widget 115-3.

Referring back to FIG. 3, in an operation 320, the at least one processor 210 may identify an expanded size of a widget to be expanded based on receiving an input (or detecting an event) for expanding a size of the widget and may check whether to maintain an arrangement of one or more remaining widgets among the widgets to display the widget having the expanded size in a screen according to the expanded size of the widget. For example, the expanded size of the widget to be expanded may be described as a changed display size to expand a display size of the widget to be expanded. For example, the at least one processor 210 may identify the changed display size of the widget. For example, the expanded size of the widget to be expanded may be determined in advance for each of widgets.

In an operation 330, the at least one processor 210 may determine (YES) to maintain the arrangement of the one or more remaining widgets. For example, the at least one processor 210 may display the widget having the expanded size in (both) a first area in a screen in which the widget is displayed before receiving the input (or detecting the event) and a second area in a screen including a blank area in a screen adjacent to the first area, based on the determination to maintain the arrangement of the one or more remaining widgets.

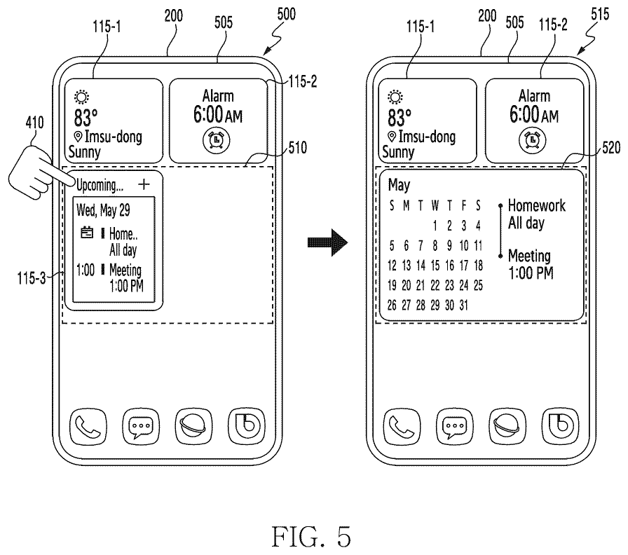

Criteria for determining whether to maintain the arrangement of the one or more remaining widgets and displaying the widget having the expanded size while maintaining the arrangement of the one or more remaining widgets are exemplified in the description of FIG. 5.

FIG. 5 illustrates an example of a widget having an expanded size displayed while maintaining an arrangement of one or more remaining widgets.

Referring to FIG. 5, a state 500 may be described as a state before a size of a widget 115-3 is expanded. For example, in the state 500, at least one processor 210 may identify an expanded size 510 of the widget 115-3 to be expanded based on an input 410 for expanding the size of the widget 115-3. For example, the at least one processor 210 may identify a first area in a screen 505 in which the widget 115-3 is displayed based on the input 410 for expanding the size of the widget 115-3. The first area is the present location in which the widget 115-3 is displayed in the screen 505 before expansion. For example, the at least one processor 210 may identify a blank area in the screen 505 adjacent to the first area based on the input 410 for expanding the size of the widget 115-3.

For example, the at least one processor 210 may determine whether to maintain an arrangement of one or more remaining widgets 115-1 and 115-2 to display the widget 115-3 having the expanded size 510 in the screen 505 by comparing the expanded size 510 of the widget 115-3 with a second area including the first area and the blank area. The second area may include the first area presently displaying the widget 115-3 and the blank area that is available to display at least a portion of the widget 115-3. The at least one processor 210 may determine that the second area can accommodate the expanded size 510 in the screen 505. For example, the at least one processor 210 may determine to maintain the arrangement of the one or more remaining widgets 115-1 and 115-2 based on the second area that is greater than or equal to the expanded size 510 of the widget 115-3. For example, based on the determination to maintain the arrangement of the one or more remaining widgets 115-1 and 115-2 (or if a widget 520 having the expanded size 510 can be displayed in the second area), an electronic device 200 may switch from the state 500 to a state 515.

For example, in the state 515, the at least one processor 210 may display the widget 520 having the expanded size 510 in the second area. For example, the at least one processor 210 may provide a response to the input 410 by displaying the widget 520 having the expanded size 510. For example, the widget 520 having the expanded size 510 of the widget 115-3 may include additional information provided from a software application related to the widget 115-3. For example, the at least one processor 210 may provide additional information to a user by displaying the widget 520 having the expanded size 510. For example, the at least one processor 210 may maintain providing information on the one or more remaining widgets 115-1 and 115-2 to the user by displaying the widget 520 having the expanded size 510 together with the one or more remaining widgets 115-1 and 115-2.

According to another embodiment, the at least one processor 210 may display the widget 520 having the expanded size 510 while the input 410 (e.g., a long press input) for expanding the size of the widget 115-3 is maintained. For example, the at least one processor 210 may display the widget 520 having the expanded size 510 while a touch input having a contact point on an area other than an executable area of the widget 115-3 is maintained. For example, the at least one processor 210 may cease displaying the widget 520 having the expanded size 510 and may display the widget 115-3 before the expansion as the touch input is released.

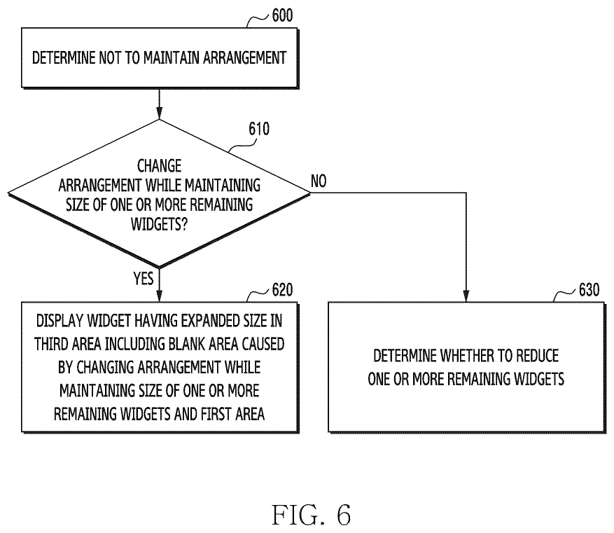

Referring back to FIG. 3, in an operation 340, the at least one processor 210 may determine (NO) not to maintain the arrangement of the one or more remaining widgets based on the second area (e.g., the second area of FIG. 5) that is smaller than the expanded size (e.g., the expanded size 510 of FIG. 5) of the widget. For example, the at least one processor 210 may determine whether to change the arrangement of the one or more remaining widgets while maintaining the size of the one or more remaining widgets, based on the determination not to maintain the arrangement of the one or more remaining widgets. While maintaining the size of the one or more remaining widgets, displaying the widget having the expanded size according to whether to change the arrangement of the one or more remaining widgets is exemplified in the description of FIG. 6.

FIG. 6 is a flowchart illustrating exemplary operations of an electronic device for expanding a size of a widget by changing an arrangement of one or more remaining widgets.

Referring to FIG. 6, in an operation 600, at least one processor 210 may determine not to maintain an arrangement of one or more remaining widgets based on a second area (e.g., the second area of FIG. 5) that is smaller than an expanded size (e.g., the expanded size 510 of FIG. 5) of a widget. For example, an operation of determining not to maintain the arrangement of the one or more remaining widgets may correspond to the operation 340 of FIG. 3.

In an operation 610, the at least one processor 210 may determine or check whether to change the arrangement of the one or more remaining widgets while maintaining a size of the one or more remaining widgets, based on the determination not to maintain the arrangement of the one or more remaining widgets.

In an operation 620, the at least one processor 210 may determine (YES) to change the arrangement of the one or more remaining widgets while maintaining the size of the one or more remaining widgets. For example, the at least one processor 210 may display a widget having an expanded size in a first area in a screen in which the widget is displayed before receiving an input (or detecting an event) and a third area in a screen including a blank area in a screen caused by changing the arrangement of the one or more remaining widgets based on the determination to change the arrangement of the one or more remaining widgets while maintaining the size of the one or more remaining widgets.

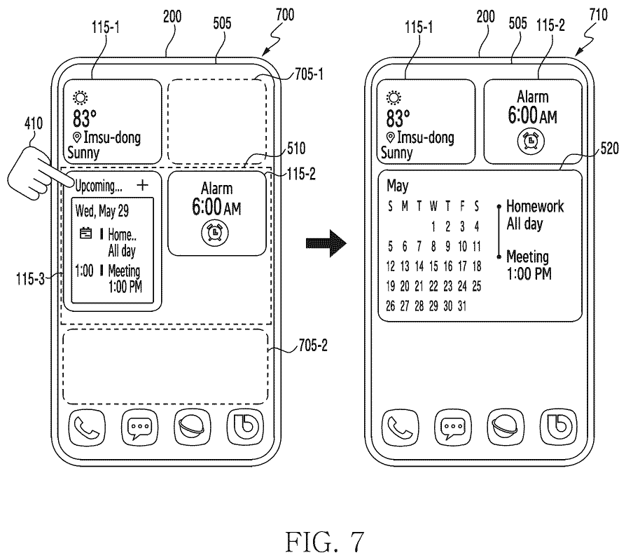

Criteria for determining whether to change the arrangement of the one or more remaining widgets while maintaining the size of the one or more remaining widgets and displaying the widget having the expanded size by changing the arrangement of the one or more remaining widgets while maintaining the size of the one or more remaining widgets are exemplified in the description of FIG. 7.

FIG. 7 illustrates an example of a widget having an expanded size displayed in a blank area caused by changing an arrangement of one or more remaining widgets.

Referring to FIG. 7, a state 700 may be described as a state before a size of a widget 115-3 is expanded. For example, in the state 700, at least one processor 210 may determine whether to maintain an arrangement of one or more remaining widgets 115-1 and 115-2 to display the widget 115-3 in a screen 505, based on an input 410 for expanding the size of the widget 115-3. For example, the at least one processor 210 may determine not to maintain the arrangement of the one or more remaining widgets 115-1 and 115-2 based on a second area that is smaller than an expanded size 510 of the widget 115-3.

For example, the at least one processor 210 may identify a blank area in the screen 505 caused by changing the arrangement of the one or more remaining widgets 115-1 and 115-2 based on the determination not to maintain the arrangement of the one or more remaining widgets 115-1 and 115-2. For example, the at least one processor 210 may change the arrangement of the one or more remaining widgets 115-1 and 115-2 by moving at least one widget (e.g., the widget 115-2) among the one or more remaining widgets 115-1 and 115-2 to a blank area 705-1 or 705-2 in the screen 505 before changing the arrangement of the one or more remaining widgets 115-1 and 115-2. For example, the at least one processor 210 may identify a first area in the screen 505 in which the widget 115-3 is displayed and a third area in the screen 505 that includes a blank area (e.g., a second blank area that is different from blank areas 705-1 and 705-2) in the screen 505 caused by changing the arrangement of the one or more remaining widgets 115-1 and 115-2. In one or more embodiments, the second blank area, which is encompassed by the third area, may be a result of moving or changing the arrangement of at least one of the remaining widgets 115-1 or 115-2; moreover, the second blank area may include the previous location of the at least one of the remaining widgets 115-1 or 115-2 that has been removed.

For example, the at least one processor 210 may determine whether to change the arrangement of the one or more remaining widgets 115-1 and 115-2 while maintaining a size of the one or more remaining widgets 115-1 and 115-2 to display the widget 115-3 having an expanded size 510 in the screen 505 by comparing the expanded size 510 of the widget 115-3 and the third area. For example, the at least one processor 210 may determine to change the arrangement of the one or more remaining widgets 115-1 and 115-2 while maintaining the size of the one or more remaining widgets 115-1 and 115-2 based on the third area that is greater than or equal to the expanded size 510 of the widget 115-3. For example, based on the determination to change the arrangement of the one or more remaining widgets 115-1 and 115-2 while maintaining the size of the one or more remaining widgets 115-1 and 115-2, an electronic device 200 may switch from the state 700 to a state 710.

For example, in the state 710, the at least one processor 210 may generate the third area by changing the arrangement of the one or more remaining widgets 115-1 and 115-2, and display a widget 520 having the expanded size 510 in the third area. For example, the at least one processor 210 may provide additional information to a user by displaying the widget 520 having the expanded size 510. For example, the at least one processor 210 may maintain providing information on the one or more remaining widgets 115-1 and 115-2 to the user by displaying the widget 520 having the expanded size 510 together with the one or more remaining widgets 115-1 and 115-2.

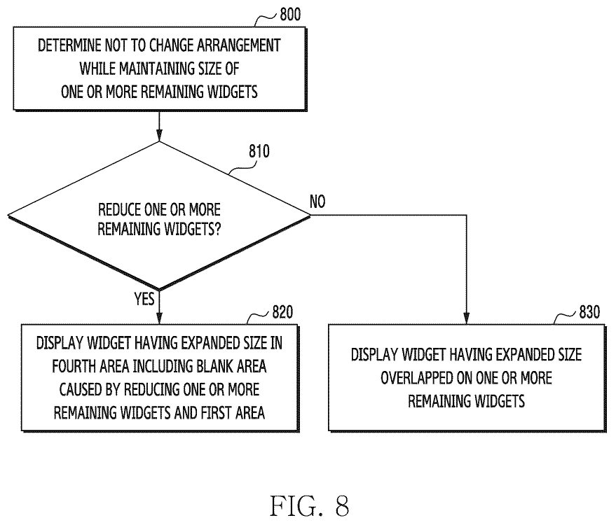

Referring back to FIG. 6, in an operation 630, the at least one processor 210 may determine (NO) not to change the arrangement of the one or more remaining widgets while maintaining the size of the one or more remaining widgets based on the third area (e.g., the third area of FIG. 7) that is smaller than the expanded size (e.g., the expanded size 510 of FIG. 7) of the widget. For example, the at least one processor 210 may determine whether to reduce the one or more remaining widgets based on the determination not to change the arrangement of the one or more remaining widgets while maintaining the size of the one or more remaining widgets. Displaying the widget having the expanded size according to whether to reduce the size of the one or more remaining widgets is exemplified in the description of FIG. 8.

FIG. 8 is a flowchart illustrating exemplary operations of an electronic device for expanding a size of a widget according to whether to reduce one or more remaining widgets.

Referring to FIG. 8, in an operation 800, at least one processor 210 may determine not to change an arrangement of one or more remaining widgets while maintaining a size of the one or more remaining widgets based on a third area (e.g., the third area of FIG. 7) that is smaller than an expanded size (e.g., the expanded size 510 of FIG. 7) of a widget. For example, an operation of determining not to change the arrangement of the one or more remaining widgets while maintaining the size of the one or more remaining widgets may correspond to the operation 630 of FIG. 6.

In an operation 810, the at least one processor 210 may determine or check whether to reduce the one or more remaining widgets based on the determination not to change the arrangement of the one or more remaining widgets while maintaining the size of the one or more remaining widgets.

In an operation 820, the at least one processor 210 may determine to reduce the one or more remaining widgets. In one or more embodiments, the at least one processor 210 may determine to reduce the size of the one of the remaining widgets in order to accommodate an expanded size of the widget. For example, the at least one processor 210 may display a widget having the expanded size in a first area in a screen in which the widget is displayed before receiving an input (or detecting an event) and a fourth area in a screen including a blank area in a screen caused by reducing the one or more remaining widgets based on the determination to reduce the one or more remaining widgets.

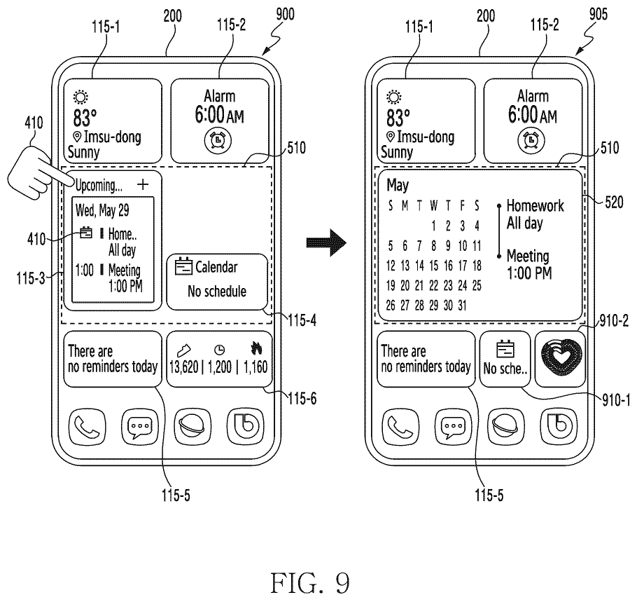

Criteria for determining whether to reduce the one or more remaining widgets and displaying the widget having the expanded size by reducing the one or more remaining widgets are exemplified in the description of FIG. 9.

FIG. 9 illustrates an example of a widget having an expanded size displayed in a blank area caused by reducing one or more remaining widgets.

Referring to FIG. 9, a state 900 may be described as a state before a size of a widget 115-3 is expanded. For example, in the state 900, at least one processor 210 may determine whether to maintain an arrangement of one or more remaining widgets 115-1, 115-2, 115-4, 115-5, and 115-6 to display the widget 520 of an expanded size 510 in a screen 505, based on an input 410 for expanding the size of the widget 115-3. For example, the at least one processor 210 may determine not to maintain the arrangement of the one or more remaining widgets 115-1, 115-2, 115-4, 115-5, and 115-6 based on a second area that is smaller than the expanded size 510 of the widget 115-3.

For example, the at least one processor 210 may determine whether to change the arrangement of the one or more remaining widgets 115-1, 115-2, 115-4, 115-5, and 115-6 while maintaining a size of one or more remaining widgets 115-1, 115-2, 115-4, 115-5, and 115-6 to display the widget 520 of the expanded size 510 in the screen 505, based on the determination not to maintain the arrangement of the one or more remaining widgets 115-1, 115-2, 115-4, 115-5, and 115-6. For example, the at least one processor 210 may determine not to change the arrangement of the one or more remaining widgets 115-1, 115-2, 115-4, 115-5, and 115-6 while maintaining the size of the one or more remaining widgets 115-1, 115-2, 115-4, 115-5, and 115-6 based on a third area that is smaller than the expanded size 510 of the widget 115-3.

For example, the at least one processor 210 may identify reducible widgets (e.g., the widget 115-4 and the widget 115-6) among the one or more remaining widgets 115-1, 115-2, 115-4, 115-5, and 115-6 and a reduced size of the reducible widgets (e.g., the widget 115-4 and the widget 115-6) based on the determination not to change the arrangement of the one or more remaining widgets 115-1, 115-2, 115-4, 115-5, and 115-6 while maintaining the size of the one or more remaining widgets 115-1, 115-2, 115-4, 115-5, and 115-6. For example, reducing the one or more remaining widgets 115-1, 115-2, 115-4, 115-5, and 115-6 may correspond to reducing the reducible widgets 115-4 and 115-6 among the one or more remaining widgets 115-1, 115-2, 115-4, 115-5, and 115-6.

For example, the at least one processor 210 may identify a blank area in the screen 505 caused by reducing the reducible widgets 115-4 and 115-6 to the reduced size based on identifying the reducible widgets 115-4 and 115-6 and the reduced size of the reducible widgets 115-4 and 115-6. For example, the at least one processor 210 may identify a first area in the screen 505 in which the widget 115-3 is displayed and a fourth area in the screen 505 including the blank area caused by reducing the reducible widgets 115-4 and 115-6.

For example, the at least one processor 210 may determine whether to reduce the reducible widgets (e.g., the widget 115-4 and the widget 115-6) according to the expanded size 510 of the widget 115-3 and the reduced size of the reducible widgets 115-4 and 115-6. For example, by comparing the expanded size 510 of the widget 115-3 with the fourth area, the at least one processor 210 may determine to reduce the reducible widgets 115-4 and 115-6 to display the widget 115-3 having the expanded size 510 in the screen 505. For example, the at least one processor 210 may determine to reduce the reducible widgets 115-4 and 115-6 based on the fourth area that is greater than or equal to the expanded size 510 of the widget 115-3. The at least one processor 210 may determine that the fourth area has a size to accommodate the expanded size 510 of the widget 115-3 after reducing and arranging the reducible widgets 115-4 and 115-6, according to one or more embodiments. For example, based on the determination to reduce the reducible widgets 115-4 and 115-6, an electronic device 200 may switch from the state 900 to a state 905.

For example, in the state 905, the at least one processor 210 may display widgets 910-1 and 910-2 having a reduced size in the screen 505 by reducing the reducible widgets 115-4 and 115-6. For example, the at least one processor 210 may generate the fourth area by reducing the reducible widgets 115-4 and 115-6 and display the widget 520 having the expanded size 510 in the fourth area. In one or more embodiments, after reducing the reducible widgets 115-4 and 115-6, the fourth area may have the size to accommodate the expanded size 510 for displaying the widget 520. For example, the at least one processor 210 may provide additional information to a user by displaying the widget 520 having the expanded size 510. For example, the at least one processor 210 may maintain providing information on the one or more remaining widgets 115-1, 115-2, 115-4, 115-5, and 115-6 to the user by displaying the widget 520 having the expanded size 510 together with the one or more remaining widgets 115-1, 115-2, and 115-5 and the widgets 910-1 and 910-2 having the reduced size.

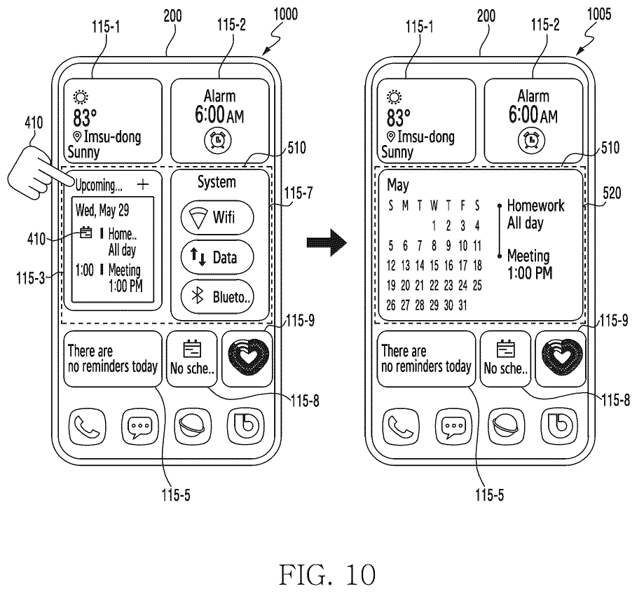

Referring back to FIG. 8, in an operation 830, the at least one processor 210 may determine (NO) not to reduce the size of the one or more remaining widgets based on the fourth area (e.g., the fourth area of FIG. 9) that is smaller than the expanded size (e.g., the expanded size 510 of FIG. 9) of the widget. For example, the at least one processor 210 may display the widget having the expanded size overlapped on the one or more remaining widgets based on the determination not to reduce the size of the one or more remaining widgets. Displaying the widget having the expanded size overlapped on the one or more remaining widgets according to the determination not to reduce the size of the one or more remaining widgets is exemplified in the description of FIG. 10.

FIG. 10 illustrates an example of a widget having an expanded size displayed by overlapping on one or more remaining widgets.

Referring to FIG. 10, a state 1000 may be described as a state before a size of a widget 115-3 is expanded. For example, in the state 1000, at least one processor 210 may determine whether to maintain an arrangement of one or more remaining widgets 115-1, 115-2, 115-5, 115-7, 115-8, and 115-9 to display a widget 520 of an expanded size 510 in a screen 505, based on an input 410 for expanding the size of the widget 115-3. For example, the at least one processor 210 may determine not to maintain the arrangement of the one or more remaining widgets 115-1, 115-2, 115-5, 115-7, 115-8, and 115-9 based on a second area that is smaller than the expanded size 510 of the widget 115-3.

For example, the at least one processor 210 may determine whether to change the arrangement of the one or more remaining widgets 115-1, 115-2, 115-5, 115-7, 115-8, and 115-9 while maintaining a size of the one or more remaining widgets 115-1, 115-2, 115-5, 115-7, 115-8, and 115-9 to display the widget 520 of the expanded size 510 in the screen 505, based on the determination not to maintain the arrangement of the one or more remaining widgets 115-1, 115-2, 115-5, 115-7, 115-8, and 115-9. For example, the at least one processor 210 may determine not to change the arrangement of the one or more remaining widgets 115-1, 115-2, 115-5, 115-7, 115-8, and 115-9 while maintaining the size of the one or more remaining widgets 115-1, 115-2, 115-5, 115-7, 115-8, and 115-9 based on a third area that is smaller than the expanded size 510 of the widget 115-3.

For example, the at least one processor 210 may determine whether to reduce the one or more remaining widgets 115-1, 115-2, 115-5, 115-7, 115-8, and 115-9 to display the widget 520 of the expanded size 510 in the screen 505 based on the determination not to change the arrangement of the one or more remaining widgets 115-1, 115-2, 115-5, 115-7, 115-8, and 115-9 while maintaining the size of the one or more remaining widgets 115-1, 115-2, 115-5, 115-7, 115-8, and 115-9. For example, the at least one processor 210 may determine not to reduce the one or more remaining widgets 115-1, 115-2, 115-5, 115-7, 115-8, and 115-9 based on a fourth area that is smaller than the expanded size 510 of the widget 115-3. For example, based on the determination not to reduce the one or more remaining widgets 115-1, 115-2, 115-5, 115-7, 115-8, and 115-9, an electronic device 200 may switch from a state 1000 to the state 1005.

For example, in the state 1005, the at least one processor 210 may display the widget 520 having the expanded size 510, overlapped on the one or more remaining widgets 115-1, 115-2, 115-5, 115-7, 115-8, and 115-9, in the screen 505. For example, the at least one processor 210 may cease displaying at least one widget 115-7 adjacent to the widget 115-3 among the one or more remaining widgets 115-1, 115-2, 115-5, 115-7, 115-8, and 115-9 by displaying the widget 520 having the expanded size 510. For example, the at least one processor 210 may provide additional information to a user by displaying the widget 520 having the expanded size 510 even when providing information on the widget 115-7 to the user is not maintained by ceasing the display of the widget 115-7. For example, the at least one processor 210 may maintain providing information on the one or more remaining widgets 115-1, 115-2, 115-5, 115-8, and 115-9 excluding the widget 115-7 by displaying the widget 520 having the expanded size 510, together with the one or more remaining widgets 115-1, 115-2, 115-5, 115-8, and 115-9 excluding the widget 115-7.

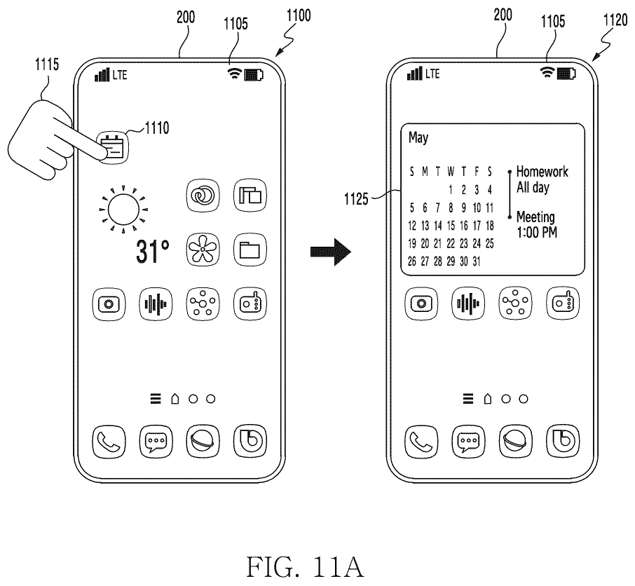

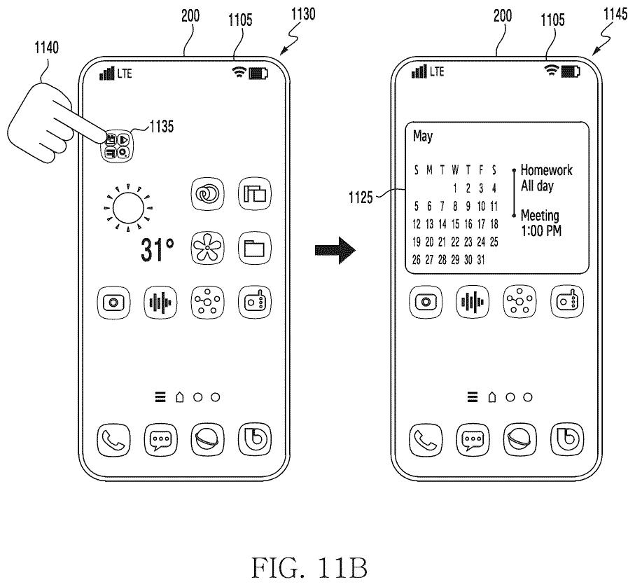

For example, the at least one processor 210 may receive an input to an object (e.g., an icon of a software application) corresponding to the software application. For example, the at least one processor 210 may display a widget based on the input to the object corresponding to the software application. Displaying the widget based on the input to the object corresponding to the software application is exemplified in the description of FIG. 11A.

FIG. 11A illustrates an example of a widget displayed based on an input to an object corresponding to a software application.

Referring to FIG. 11A, a state 1100 may be described as a state in which objects and widgets corresponding to a software application are displayed. For example, in the state 1100, at least one processor 210 may display a screen 1105 provided from a home screen application through a display 230. For example, the at least one processor 210 may display the objects and the widgets corresponding to the software application in the screen 1105. For example, an object corresponding to the software application may be described as an executable object (or an icon) for executing the software application. For example, the object corresponding to the software application may be displayed as an image representing (or indicating) the software application corresponding to the object. For example, the object corresponding to the software application may be displayed as a fixed image.

For example, a widget may be displayed as deformable images, unlike the object corresponding to the software application. For example, in the widget, information provided from the software application may be displayed by executing the software application related to the widget. For example, the widget may be referred to as a mini-application for the software application related to the widget.

For example, the at least one processor 210 may receive an input 1115 to an object 1110, from among objects corresponding to the software application displayed in the screen 1105, corresponding to one software application. For example, the input 1115 may be distinguished from an input for executing the software application. For example, the input 1115 may be described as an input for displaying a widget 1125 related to the software application corresponding to the object 1110. As a non-limiting example, the input 1115 may include a double tap input having a contact point on the object 1110 corresponding to the software application, a long press input having a contact point on the object 1110 corresponding to the software application, and/or a drag input from the object 1110 corresponding to the software application. However, it is not limited thereto.

For example, the at least one processor 210 may identify the widget 1125 related to the software application corresponding to the object 1110 based on the input 1115. For example, the at least one processor 210 may identify a size of the widget 1125. For example, the widget 1125 may have a size larger than the object 1110 corresponding to the software application. For example, the at least one processor 210 may determine a method of displaying the widget 1125 having the size larger than that of the object 1110. For example, an operation of determining the method of displaying the widget 1125 may refer to methods of displaying the widget having the expanded size exemplified in the description of FIGS. 3 to 10. For example, based on the input 1115, an electronic device 200 may switch from the state 1100 to a state 1120.

For example, in the state 1120, the at least one processor 210 may display the widget 1125 related to the software application corresponding to the object 1110 in the screen 1105. For example, the at least one processor 210 may provide additional information related to the software application corresponding to the object 1110 to a user by displaying the widget 1125 related to the software application corresponding to the object 1110. For example, the at least one processor 210 may maintain providing information on other objects and other widgets corresponding to the software application to the user, by refraining from displaying a screen provided by the software application corresponding to the object 1110 in a full screen and displaying the widget 1125 related to the software application corresponding to the object 1110 together with the other objects and the other widgets corresponding to the software application. For example, the at least one processor 210 may receive an input to the other objects and the other widgets corresponding to the software application while the widget 1125 is displayed, by refraining from displaying the screen provided by the software application corresponding to the object 1110 in the full screen and displaying the widget 1125 related to the software application corresponding to the object 1110 together with the other objects and the other widgets corresponding to the software application.

FIG. 11B illustrates an example of a widget displayed based on an input to a folder including an object corresponding to a software application.

Referring to FIG. 11B, a state 1130 may be described as a state in which a folder 1135 including objects corresponding to a software application, objects corresponding to the software application are displayed, and widgets. For example, in the state 1130, at least one processor 210 may display a screen 1105 provided from a home screen application through a display 230. For example, the at least one processor 210 may display the folder 1135 including the objects corresponding to the software application, and the objects and the widgets corresponding to the software application in the screen 1105. For example, the folder 1135 including the objects corresponding to the software application may be described as an executable object for displaying a pop-up menu including objects corresponding to one or more software applications. For example, the folder 1135 may include a preview icon of the objects corresponding to the one or more software applications in the folder 1135. For example, the at least one processor 210 may display the pop-up menu including the objects corresponding to the one or more software applications in the folder on a portion adjacent to the folder 1135, based on an input to the folder 1135. For example, the at least one processor 210 may execute a software application corresponding to an object based on an input to the object corresponding to the software application in the pop-up menu.

For example, the at least one processor 210 may receive an input 1140 for displaying a widget 1125 related to a software application in the folder 1135. For example, the input 1140 may be distinguished from an input for displaying the pop-up menu including the objects corresponding to the one or more software applications in the folder 1135. As a non-limiting example, the input 1140 may include a double tap input having a contact point on the folder 1135, a long press input having a contact point on the folder 1135, a drag input from the folder 1135, and/or a hover input close to an area displaying the folder 1135. However, it is not limited thereto.

For example, the at least one processor 210 may identify the widget 1125 related to the software application in the folder 1135 based on the input 1140. For example, the widget 1125 may include, among the one or more software applications in the folder 1135, a widget related to a software application (e.g., a first software application in the folder, or a software application that provides a widget function) representing the folder.

For example, the at least one processor 210 may identify a size of the widget 1125. For example, the widget 1125 may have a size larger than the folder 1135. For example, the at least one processor 210 may determine a method of displaying the widget 1125 having the size larger than the folder 1135. For example, an operation of determining the method of displaying the widget 1125 may refer to methods of displaying the expanded widget exemplified in the description of FIGS. 3 to 10. For example, based on the input 1140, an electronic device 200 may switch from the state 1130 to a state 1145.

For example, in the state 1145, the at least one processor 210 may display the widget 1125 related to the software application in the folder 1135 in the screen 1105. For example, the at least one processor 210 may provide additional information associated with the widget 1125 related to the software application in the folder 1135 to a user, by displaying the widget 1125 related to the software application in the folder 1135. For example, the at least one processor 210 may maintain providing information on other objects and other widgets corresponding to the software application to the user, by displaying the widget 1125 related to the software application in the folder 1135, together with the other objects and the other widgets corresponding to the software application. For example, the at least one processor 210 may receive an input to the other objects and the other widgets corresponding to the software application while the widget 1125 is displayed, by displaying the widget 1125 related to the software application in the folder 1135, together with the other objects and the other widgets corresponding to the software application.

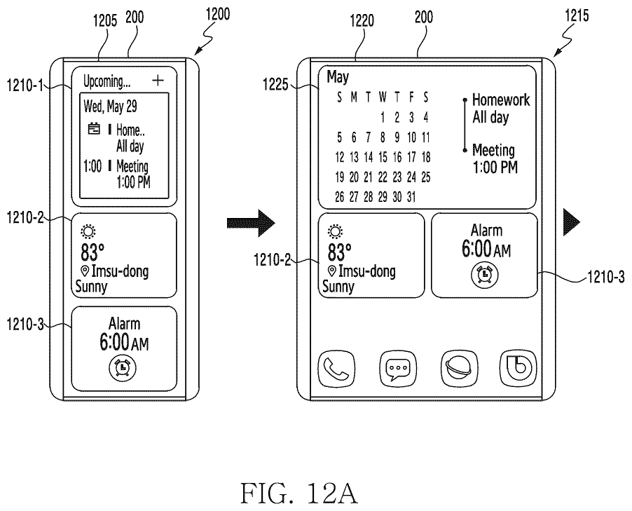

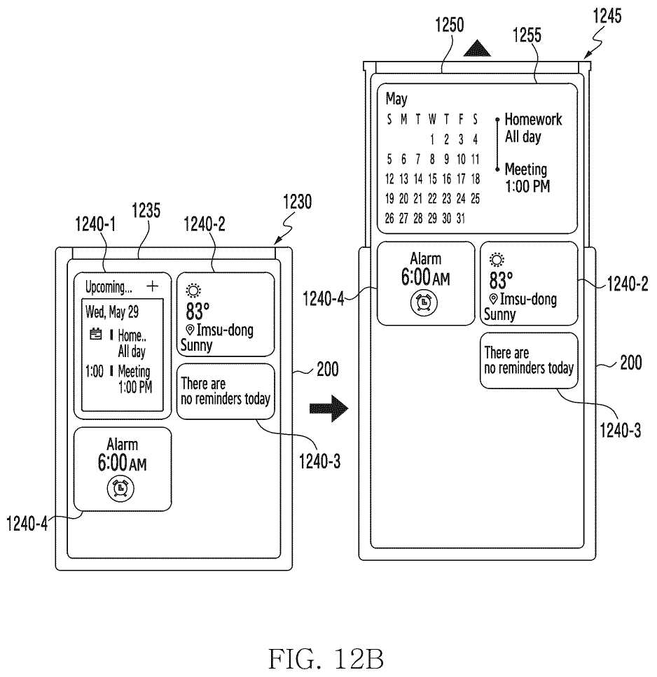

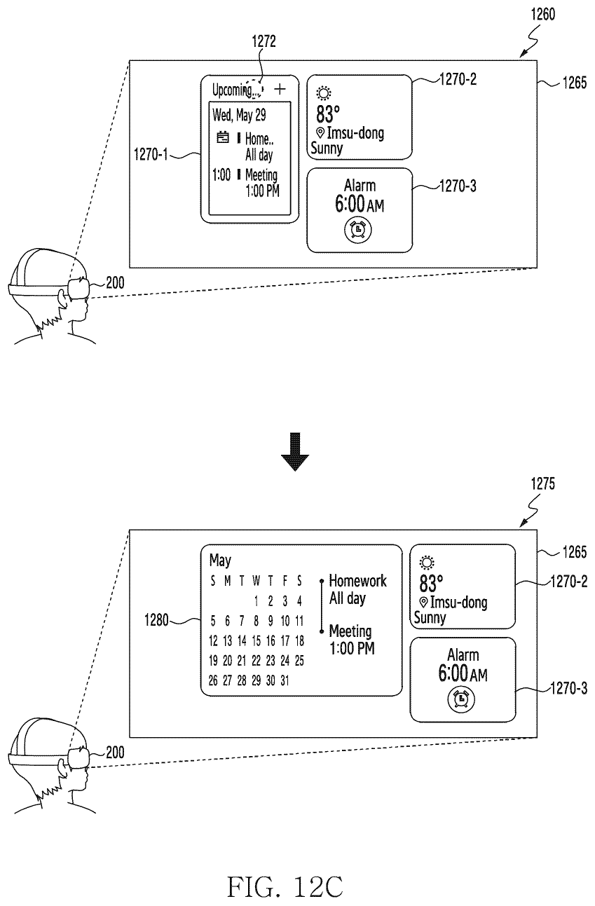

For example, the electronic device 200 may be one of various shapes of mobile devices, such as smartphones (e.g., a foldable type smartphone or a rollable type smartphone) with various form factors and/or a head mounted device (HMD). An input (or an event) for expanding a size of a widget of the electronic device 200 having various shapes and a method of displaying the widget having the expanded size are exemplified in FIGS. 12A, 12B, and 12C.

FIGS. 12A, 12B, and 12C illustrate an example of a method of expanding a size of a widget according to a type of an electronic device.

Referring to FIG. 12A, an electronic device 200 may be described as a foldable type smartphone. For example, the electronic device 200 may further include a first housing part, a second housing part, and a flexible display.

For example, the flexible display may include a display area configured to be partially bent according to the second housing part that rotates with respect to the first housing part. For example, the flexible display may be disposed in the first housing part and the second housing part.

For example, a state 1200 may be described as a folded state of the electronic device 200. For example, in the state 1200, at least one processor 210 may display a screen 1205 through a flexible display in the first housing part. For example, the at least one processor 210 may display a plurality of widgets 1210-1, 1210-2, and 1210-3 in the screen 1205. For example, the at least one processor 210 may detect an event that changes the folded state of the electronic device 200 to an unfolded state of the electronic device 200 while displaying the plurality of widgets 1210-1, 1210-2, and 1210-3 in the screen 1205. For example, the electronic device 200 may switch from the state 1200 to a state 1215 based on the detection of the event that changes the folded state of the electronic device 200 to the unfolded state of the electronic device 200.

For example, the state 1215 may be described as the unfolded state of the electronic device 200. For example, in the state 1215, the at least one processor 210 may expand a size of the widget 1210-1 among the plurality of widgets 1210-1, 1210-2, and 1210-3 in response to the event of changing the folded state of the electronic device 200 to the unfolded state of the electronic device 200. For example, among the plurality of widgets 1210-1, 1210-2, and 1210-3, a widget expanded in response to the event of changing the folded state of the electronic device 200 to the unfolded state of the electronic device 200 may be predetermined or determined as the expandable widget 1210-1. For example, the at least one processor 210 may display a screen 1220 in the flexible display disposed in the first housing part and the second housing part in response to the event of changing the folded state of the electronic device 200 to the unfolded state of the electronic device 200.

For example, the at least one processor 210 may display, in the expanded screen 1220, a widget 1225 having an expanded size by changing an arrangement of one or more remaining widgets 1210-2 and 1210-3 or reducing the one or more remaining widgets 1210-2 and 1210-3. For example, the at least one processor 210 may display the widget 1225 having the expanded size overlapped on the one or more remaining widgets 1210-2 and 1210-3. For example, determining a method of displaying the widget 1225 having the expanded size in the expanded screen 1220 may refer to a method of displaying the widget having the expanded size exemplified in the description of FIGS. 3 to 10.

For example, the at least one processor 210 may provide additional information to a user by displaying the widget 1225 having the expanded size in the expanded screen 1220. For example, the at least one processor 210 may maintain providing information on the one or more remaining widgets 1210-2 and 1210-3 to the user by displaying the widget 1225 having the expanded size, together with the one or more remaining widgets 1210-2 and 1210-3.

Referring to FIG. 12B, an electronic device 200 may be described as a rollable type smartphone. For example, the electronic device 200 may further include a first housing part, a second housing part, and a flexible display.

For example, the second housing part may be movably coupled with respect to the first housing part between a reduced state and an expanded state of the electronic device 200.

For example, the flexible display may include a first display area and a second display area. For example, the first display area of the flexible display may be disposed on the first housing part. For example, the second display area of the flexible display may extend from the first display area and may be configured to be rolled into the first housing part along the second housing part moved with respect to the first housing part or exposed to the outside of the first housing part.

For example, a state 1230 may be described as the reduced state of the electronic device 200. For example, in the state 1230, the at least one processor 210 may display a screen 1235 through the first display area of the flexible display. For example, the at least one processor 210 may display a plurality of widgets 1240-1, 1240-2, 1240-3, and 1240-4 in the screen 1235. For example, the at least one processor 210 may detect an event of changing the electronic device 200 from the reduced state to the expanded state while displaying the plurality of widgets 1240-1, 1240-2, 1240-3, and 1240-4 within the screen 1235. For example, based on the detection of the event of changing the electronic device 200 from the reduced state to the expanded state, the electronic device 200 may switch from the state 1230 to a state 1245.

As another embodiment, the at least one processor 210 may change the electronic device 200 from the reduced state to the expanded state based on receiving an input (or detecting an event) for expanding the widget 1240-1. For example, receiving the input (or detecting the event) for expanding the widget 1240-1 may refer to the description of FIGS. 4A and 4B.

For example, the state 1245 may be described as a state in which the electronic device 200 is expanded. For example, in the state 1245, the at least one processor 210 may expand a size of the widget 1240-1 among the plurality of widgets 1240-1, 1240-2, 1240-3, and 1240-4 in response to the event of changing the electronic device 200 from the reduced state to the expanded state. For example, among the plurality of widgets 1240-1, 1240-2, 1240-3, and 1240-4, a widget expanded in response to the event of changing the electronic device 200 from the reduced state to the expanded state may be predetermined or determined as the expandable widget 1240-1. For example, the at least one processor 210 may display a screen 1250 in the first display area and the second display area of the flexible display in response to the event of changing the electronic device 200 from the reduced state to the expanded state.

For example, the at least one processor 210 may display, in the expanded screen 1250, the widget 1255 having an expanded size by changing an arrangement of the one or more remaining widgets 1240-2, 1240-3, and 1240-4 or reducing the one or more remaining widgets 1240-2, 1240-3, and 1240-4. For example, the at least one processor 210 may display the widget 1255 having the expanded size overlapped on the one or more remaining widgets 1240-2, 1240-3, and 1240-4. For example, determining a method of displaying the widget 1255 having the expanded size in the expanded screen 1250 may refer to a method of displaying the widget having the expanded size exemplified in the description of FIGS. 3 to 10.

For example, the at least one processor 210 may provide additional information to a user by displaying the widget 1255 having the expanded size in the expanded screen 1250. For example, the at least one processor 210 may maintain to provide information on the one or more remaining widgets 1240-2, 1240-3, and 1240-4 to the user by displaying the widget 1255 having the expanded size, together with the one or more remaining widgets 1240-2, 1240-3, and 1240-4.

Referring to FIG. 12C, an electronic device 200 may include a head-mounted display (HMD) wearable on a head of a user. For example, the electronic device 200 may be described as a head-mounted display (HMD) device, a headgear electronic device, a glasses-type (or goggle-type) electronic device, a video see-through (or visible see-through) (VST) device, an extended reality (XR) device, a virtual reality (VR) device, and/or an augmented reality (AR) device.

For example, the at least one processor 210 may provide a three-dimensional (3D) space 1265 through the display 230. For example, the at least one processor 210 may display widgets 1270-1, 1270-2, and 1270-3 in the 3D space 1265.

For example, a state 1260 may be described as a state before the widget 1270-1 is expanded. For example, in the state 1260, the at least one processor 210 may identify a user gesture to expand a size of the widget 1270-1. For example, the electronic device 200 may further include one or more cameras arranged to face eyes of the user of the electronic device 200 when worn. For example, the at least one processor 210 may obtain images of the eyes of the user through the one or more cameras while the 3D space 1265 is provided. For example, the at least one processor 210 may identify a gaze 1272 of the user by using the images of the eyes of the user obtained through the one or more cameras. For example, the at least one processor 210 may identify that the gaze 1272 of the user is toward the widget 1270-1 by identifying the gaze 1272 of the user. For example, the at least one processor 210 may identify a user gesture (e.g., a user gesture of blinking the eyes of the user or a user gesture of opening the eyes of the user wide) for expanding the size of the widget 1270-1 while identifying that the gaze 1272 of the user is toward the widget 1270-1. For example, based on the user gesture for expanding the size of the widget 1270-1, the electronic device 200 may switch from the state 1260 to a state 1275. Other user gestures can be utilized for expanding the size of the widget 1270-1, and the at least one processor 210 may identify, through one or more external cameras, a hand gesture by the user that corresponds to expanding the size of the widget 1270-1.

For example, in the state 1275, the at least one processor 210 may display a widget 1280 having an expanded size by changing an arrangement of the one or more remaining widgets 1270-2 and 1270-3 or reducing the one or more remaining widgets 1270-2 and 1270-3. For example, the at least one processor 210 may display the widget 1280 having the expanded size overlapped on the one or more remaining widgets 1270-2 and 1270-3. For example, determining a method of displaying the widget 1280 having the expanded size may refer to a method of displaying the widget having the expanded size exemplified in the description of FIGS. 3 to 10.

For example, the at least one processor 210 may provide additional information to the user by displaying the widget 1280 having the expanded size. For example, the at least one processor 210 may maintain to provide information on the one or more remaining widgets 1270-2 and 1270-3 to the user by displaying the widget 1280 having the expanded size, together with the one or more remaining widgets 1270-2 and 1270-3.

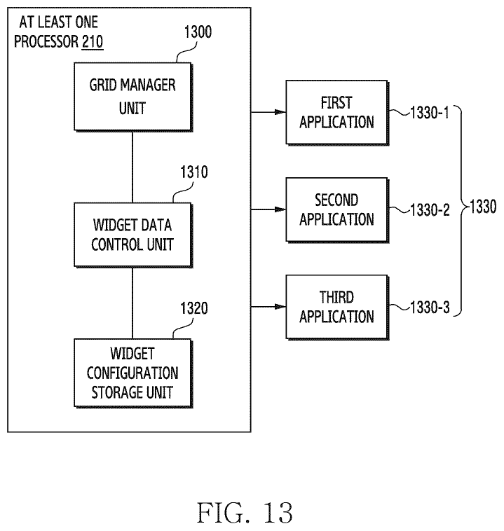

FIG. 13 illustrates an example of configurations of at least one processor.

Referring to FIG. 13, at least one processor 210 may include a grid manager unit 1300, a widget data control unit 1310, and a widget configuration storage unit 1320. For example, the grid manager unit 1300, the widget data control unit 1310, and the widget configuration storage unit 1320 may support a function of processing a widget through an algorithm stored in memory 220. For example, the grid manager unit 1300, the widget data control unit 1310, and the widget configuration storage unit 1320 are described by the term ‘unit’, but the function may be performed in software and/or functionally.

For example, the grid manager unit 1300 may determine a grid of widgets of software applications 1330. For example, the grid manager unit 1300 may display the widgets of the software applications 1330 through a display 230 according to each grid.

For example, the widget data control unit 1310 may generate the widgets of the software applications 1330. For example, the widget data control unit 1310 may identify an expanded or reduced size by changing the generated widgets of the software applications 1330. For example, the widget data control unit 1310 may store information on the expanded or reduced size of the widgets of the software applications 1330 in the memory 220 or may transmit it to the at least one processor 210.

For example, the widget configuration storage unit 1320 may store the minimum and maximum size of the widgets of the software applications 1330 in the memory 220.

FIG. 14 is a block diagram illustrating an electronic device 1401 in a network environment 1400 according to various embodiments.

Referring to FIG. 14, the electronic device 1401 in the network environment 1400 may communicate with an electronic device 1402 via a first network 1498 (e.g., a short-range wireless communication network), or at least one of an electronic device 1404 or a server 1408 via a second network 1499 (e.g., a long-range wireless communication network). According to an embodiment, the electronic device 1401 may communicate with the electronic device 1404 via the server 1408. According to an embodiment, the electronic device 1401 may include a processor 1420, memory 1430, an input module 1450, a sound output module 1455, a display module 1460, an audio module 1470, a sensor module 1476, an interface 1477, a connecting terminal 1478, a haptic module 1479, a camera module 1480, a power management module 1488, a battery 1489, a communication module 1490, a subscriber identification module(SIM) 1496, or an antenna module 1497. In some embodiments, at least one of the components (e.g., the connecting terminal 1478) may be omitted from the electronic device 1401, or one or more other components may be added in the electronic device 1401. In some embodiments, some of the components (e.g., the sensor module 1476, the camera module 1480, or the antenna module 1497) may be implemented as a single component (e.g., the display module 1460).

The processor 1420 may execute, for example, software (e.g., a program 1440) to control at least one other component (e.g., a hardware or software component) of the electronic device 1401 coupled with the processor 1420, and may perform various data processing or computation. According to an embodiment, as at least part of the data processing or computation, the processor 1420 may store a command or data received from another component (e.g., the sensor module 1476 or the communication module 1490) in volatile memory 1432, process the command or the data stored in the volatile memory 1432, and store resulting data in non-volatile memory 1434. According to an embodiment, the processor 1420 may include a main processor 1421 (e.g., a central processing unit (CPU) or an application processor (AP)), or an auxiliary processor 1423 (e.g., a graphics processing unit (GPU), a neural processing unit (NPU), an image signal processor (ISP), a sensor hub processor, or a communication processor (CP)) that is operable independently from, or in conjunction with, the main processor 1421. For example, when the electronic device 1401 includes the main processor 1421 and the auxiliary processor 1423, the auxiliary processor 1423 may be adapted to consume less power than the main processor 1421, or to be specific to a specified function. The auxiliary processor 1423 may be implemented as separate from, or as part of the main processor 1421.

The auxiliary processor 1423 may control at least some of functions or states related to at least one component (e.g., the display module 1460, the sensor module 1476, or the communication module 1490) among the components of the electronic device 1401, instead of the main processor 1421 while the main processor 1421 is in an inactive (e.g., sleep) state, or together with the main processor 1421 while the main processor 1421 is in an active state (e.g., executing an application). According to an embodiment, the auxiliary processor 1423 (e.g., an image signal processor or a communication processor) may be implemented as part of another component (e.g., the camera module 1480 or the communication module 1490) functionally related to the auxiliary processor 1423. According to an embodiment, the auxiliary processor 1423 (e.g., the neural processing unit) may include a hardware structure specified for artificial intelligence model processing. An artificial intelligence model may be generated by machine learning. Such learning may be performed, e.g., by the electronic device 1401 where the artificial intelligence is performed or via a separate server (e.g., the server 1408). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1430 may store various data used by at least one component (e.g., the processor 1420 or the sensor module 1476) of the electronic device 1401. The various data may include, for example, software (e.g., the program 1440) and input data or output data for a command related thereto. The memory 1430 may include the volatile memory 1432 or the non-volatile memory 1434.

The program 1440 may be stored in the memory 1430 as software, and may include, for example, an operating system (OS) 1442, middleware 1444, or an application 1446.

The input module 1450 may receive a command or data to be used by another component (e.g., the processor 1420) of the electronic device 1401, from the outside (e.g., a user) of the electronic device 1401. The input module 1450 may include, for example, a microphone, a mouse, a keyboard, a key (e.g., a button), or a digital pen (e.g., a stylus pen).

The sound output module 1455 may output sound signals to the outside of the electronic device 1401. The sound output module 1455 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1460 may visually provide information to the outside (e.g., a user) of the electronic device 1401. The display module 1460 may include, for example, a display, a hologram device, or a projector and control circuitry to control a corresponding one of the display, hologram device, and projector. According to an embodiment, the display module 1460 may include a touch sensor adapted to detect a touch, or a pressure sensor adapted to measure the intensity of force incurred by the touch.

The audio module 1470 may convert a sound into an electrical signal and vice versa. According to an embodiment, the audio module 1470 may obtain the sound via the input module 1450, or output the sound via the sound output module 1455 or a headphone of an external electronic device (e.g., an electronic device 1402) directly (e.g., wiredly) or wirelessly coupled with the electronic device 1401.

The sensor module 1476 may detect an operational state (e.g., power or temperature) of the electronic device 1401 or an environmental state (e.g., a state of a user) external to the electronic device 1401, and then generate an electrical signal or data value corresponding to the detected state. According to an embodiment, the sensor module 1476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1477 may support one or more specified protocols to be used for the electronic device 1401 to be coupled with the external electronic device (e.g., the electronic device 1402) directly (e.g., wiredly) or wirelessly. According to an embodiment, the interface 1477 may include, for example, a high definition multimedia interface (HDMI), a universal serial bus (USB) interface, a secure digital (SD) card interface, or an audio interface.

A connecting terminal 1478 may include a connector via which the electronic device 1401 may be physically connected with the external electronic device (e.g., the electronic device 1402). According to an embodiment, the connecting terminal 1478 may include, for example, an HDMI connector, a USB connector, a SD card connector, or an audio connector (e.g., a headphone connector).

The haptic module 1479 may convert an electrical signal into a mechanical stimulus (e.g., a vibration or a movement) or electrical stimulus which may be recognized by a user via his tactile sensation or kinesthetic sensation. According to an embodiment, the haptic module 1479 may include, for example, a motor, a piezoelectric element, or an electric stimulator.

The camera module 1480 may capture a still image or moving images. According to an embodiment, the camera module 1480 may include one or more lenses, image sensors, image signal processors, or flashes.

The power management module 1488 may manage power supplied to the electronic device 1401. According to an embodiment, the power management module 1488 may be implemented as at least part of, for example, a power management integrated circuit (PMIC).

The battery 1489 may supply power to at least one component of the electronic device 1401. According to an embodiment, the battery 1489 may include, for example, a primary cell which is not rechargeable, a secondary cell which is rechargeable, or a fuel cell.

The communication module 1490 may support establishing a direct (e.g., wired) communication channel or a wireless communication channel between the electronic device 1401 and the external electronic device (e.g., the electronic device 1402, the electronic device 1404, or the server 1408) and performing communication via the established communication channel. The communication module 1490 may include one or more communication processors that are operable independently from the processor 1420 (e.g., the application processor (AP)) and supports a direct (e.g., wired) communication or a wireless communication. According to an embodiment, the communication module 1490 may include a wireless communication module 1492 (e.g., a cellular communication module, a short-range wireless communication module, or a global navigation satellite system (GNSS) communication module) or a wired communication module 1494 (e.g., a local area network (LAN) communication module or a power line communication (PLC) module). A corresponding one of these communication modules may communicate with the external electronic device via the first network 1498 (e.g., a short-range communication network, such as Bluetooth™, wireless-fidelity (Wi-Fi) direct, or infrared data association (IrDA)) or the second network 1499 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1492 may identify and authenticate the electronic device 1401 in a communication network, such as the first network 1498 or the second network 1499, using subscriber information (e.g., international mobile subscriber identity (IMSI)) stored in the subscriber identification module 1496.

The wireless communication module 1492 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1492 may support a high-frequency band (e.g., the mmWave band) to achieve, e.g., a high data transmission rate. The wireless communication module 1492 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1492 may support various requirements specified in the electronic device 1401, an external electronic device (e.g., the electronic device 1404), or a network system (e.g., the second network 1499). According to an embodiment, the wireless communication module 1492 may support a peak data rate (e.g., 20 Gbps or more) for implementing eMBB, loss coverage (e.g., 1464 dB or less) for implementing mMTC, or U-plane latency (e.g., 0.5 ms or less for each of downlink (DL) and uplink (UL), or a round trip of 14 ms or less) for implementing URLLC.

The antenna module 1497 may transmit or receive a signal or power to or from the outside (e.g., the external electronic device) of the electronic device 1401. According to an embodiment, the antenna module 1497 may include an antenna including a radiating element composed of a conductive material or a conductive pattern formed in or on a substrate (e.g., a printed circuit board (PCB)). According to an embodiment, the antenna module 1497 may include a plurality of antennas (e.g., array antennas). In such a case, at least one antenna appropriate for a communication scheme used in the communication network, such as the first network 1498 or the second network 1499, may be selected, for example, by the communication module 1490 (e.g., the wireless communication module 1492) from the plurality of antennas. The signal or the power may then be transmitted or received between the communication module 1490 and the external electronic device via the selected at least one antenna. According to an embodiment, another component (e.g., a radio frequency integrated circuit (RFIC)) other than the radiating element may be additionally formed as part of the antenna module 1497.

According to various embodiments, the antenna module 1497 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1401 and the external electronic device 1404 via the server 1408 coupled with the second network 1499. Each of the electronic devices 1402 or 1404 may be a device of a same type as, or a different type, from the electronic device 1401. According to an embodiment, all or some of operations to be executed at the electronic device 1401 may be executed at one or more of the external electronic devices 1402, 1404, or 1408. For example, if the electronic device 1401 should perform a function or a service automatically, or in response to a request from a user or another device, the electronic device 1401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1401. The electronic device 1401 may provide the outcome, with or without further processing of the outcome, as at least part of a reply to the request. To that end, a cloud computing, distributed computing, mobile edge computing (MEC), or client-server computing technology may be used, for example. The electronic device 1401 may provide ultra low-latency services using, e.g., distributed computing or mobile edge computing. In another embodiment, the external electronic device 1404 may include an internet-of-things (IoT) device. The server 1408 may be an intelligent server using machine learning and/or a neural network. According to an embodiment, the external electronic device 1404 or the server 1408 may be included in the second network 1499. The electronic device 1401 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1440) including one or more instructions that are stored in a storage medium (e.g., internal memory 1436 or external memory 1438) that is readable by a machine (e.g., the electronic device 1401). For example, a processor (e.g., the processor 1420) of the machine (e.g., the electronic device 1401) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The technical problems to be achieved in the present disclosure are not limited to those described above, and other technical problems not mentioned herein will be clearly understood by those having ordinary knowledge in the art to which the present disclosure belongs.

As described above, the electronic device (e.g., the electronic device 200 of FIG. 2) may comprise memory (e.g., the memory 220 of FIG. 2), comprising one or more storage mediums, storing instructions, a display (e.g., the display 230 of FIG. 2), and at least one processor (e.g., the at least one processor 210 of FIG. 2) comprising processing circuitry. The instructions, when executed by the at least one processor individually or collectively, may cause the electronic device to display, through the display, a plurality of widgets. The instructions, when executed by the at least one processor individually or collectively, may cause the electronic device to, based on an external input or an event, select a widget among the plurality of widgets. The instructions, when executed by the at least one processor individually or collectively, may cause the electronic device to identify a changed display size for expanding a display size of the selected widget. The instructions, when executed by the at least one processor individually or collectively, may cause the electronic device to, based on the changed display size, identify a first area corresponding to a first blank area in the display for displaying the selected widget. The instructions, when executed by the at least one processor individually or collectively, may cause the electronic device to, if the selected widget with the changed display size is able to be displayed in the first area, display the selected widget in a second area including the first area. The instructions, when executed by the at least one processor individually or collectively, may cause the electronic device to, if the selected widget with the changed display size is not able to be displayed in the first area, display remaining widgets excluding the selected widget among the plurality of widgets by reducing a size of the remaining widgets, and display the selected widget with the changed display size in a third area corresponding to a second blank area caused by reducing the remaining widgets.

For example, the instructions, when executed by the at least one processor individually or collectively, may cause the electronic device to, based on a size of the second area that is greater than or equal to the changed display size of the selected widget, determine that the selected widget is able to be displayed in the first area as the changed display size. The instructions, when executed by the at least one processor individually or collectively, may cause the electronic device to, based on the size of the second area that is smaller than the changed display size of the selected widget, determine that the selected widget is not able to be displayed in the first area as the changed display size.

For example, the instructions, when executed by the at least one processor individually or collectively, may cause the electronic device to, based on a size of the third area that is greater than or equal to the changed display size of the selected widget, display the selected widget in the second area as the changed display size. The instructions, when executed by the at least one processor individually or collectively, may cause the electronic device to, based on the size of the third area that is smaller than the changed display size of the selected widget, display the selected widget as the changed display size by overlaying on the remaining widgets.

For example, the instructions, when executed by the at least one processor individually or collectively, may cause the electronic device to, if the selected widget is not able to be displayed in the first area as the changed display size, determine whether to change an arrangement of the remaining widgets while maintaining the size of the remaining widgets. The instructions, when executed by the at least one processor individually or collectively, may cause the electronic device to, based on determination to change the arrangement while maintaining the size of the remaining widgets, display the selected widget as the changed display size in a fourth area comprising a third blank area caused by changing the arrangement while maintaining the size of the remaining widgets. The instructions, when executed by the at least one processor individually or collectively, may cause the electronic device to, based on determination not to change the arrangement while maintaining the size of the remaining widgets, display the remaining widgets by reducing the size of the remaining widgets, and display the selected widget in the third area as the changed display size.

For example, the instructions, when executed by the at least one processor individually or collectively, may cause the electronic device to, based on a size of the fourth area that is greater than or equal to the changed display size of the selected widget, determine to change the arrangement while maintaining the size of the remaining widgets. The instructions, when executed by the at least one processor individually or collectively, may cause the electronic device to, based on the size of the fourth area that is smaller than the changed display size of the selected widget, determine not to change the arrangement while maintaining the size of the remaining widgets.

For example, the instructions, when executed by the at least one processor individually or collectively, may cause the electronic device to, if the selected widget is not able to be displayed in the first area as the changed display size, identify reducible widgets among the remaining widgets. The instructions, when executed by the at least one processor individually or collectively, may cause the electronic device to, based on the identification, compare the changed display size of the selected widget with the size of the third area, according to the changed display size of the selected widget and a reduced display size of the reducible widgets among the remaining widgets.

For example, the external input may comprise a touch input to a portion other than an executable portion on the widget, a double tap input to the widget, a long press input to the widget, or a drag input from the widget.

As described above, the method may be executed in an electronic device comprising a display. The method may comprise displaying, through the display, a screen including widgets. The method may comprise, based on an external input or an event, selecting a widget among the plurality of widgets. The method may comprise identifying a display size changed for expanding a display size of the selected widget. The method may comprise, based on the changed display size, identifying a first area corresponding to a first blank area in the display for displaying the selected widget. The method may comprise, if the selected widget with the changed display size is able to be displayed in the first area, displaying the selected widget in a second area including the first area. The method may comprise, if the selected widget with the changed display size is not able to be displayed in the first area, displaying remaining widgets excluding the selected widget among the plurality of widgets by reducing a size of the remaining widgets, and displaying the selected widget with the changed display size in a third area corresponding to a second blank area caused by reducing the remaining widgets.

For example, the method may comprise, based on a size of the second area that is greater than or equal to the changed display size of the selected widget, determining that the selected widget is able to be displayed in the first area as the changed display size. The method may comprise, based on the size of the second area that is smaller than the changed display size of the selected widget, determining that the selected widget is not able to be displayed in the first area as the changed display size.

For example, the method may comprise, based on a size of the third area that is greater than or equal to the changed display size of the selected widget, displaying the selected widget in the second area as the changed display size. The method may comprise, based on the size of the third area that is smaller than the changed display size of the selected widget, displaying the selected widget as the changed display size by overlaying on the remaining widgets.

For example, the method may comprise, if the selected widget is not able to be displayed in the first area as the changed display size, determining whether to change an arrangement of the remaining widgets while maintaining the size of the remaining widgets. The method may comprise, based on determination to change the arrangement while maintaining the size of the remaining widgets, displaying the selected widget as the changed display size in a fourth area comprising a third blank area caused by changing the arrangement while maintaining the size of the remaining widgets. The method may comprise, based on determination not to change the arrangement while maintaining the size of the remaining widgets, displaying the remaining widgets by reducing the size of the remaining widgets, and displaying the selected widget in the third area as the changed display size.

For example, the method may comprise, based on a size of the fourth area that is greater than or equal to the changed display size of the selected widget, determining to change the arrangement while maintaining the size of the remaining widgets. The method may comprise, based on the size of the fourth area that is smaller than the changed display size of the selected widget, determining not to change the arrangement while maintaining the size of the remaining widgets.

For example, the method may comprise, if the selected widget is not able to be displayed in the first area as the changed display size, identifying reducible widgets among the remaining widgets. The method may comprise, based on the identification, comparing the changed display size of the selected widget with the size of the third area, according to the changed display size of the selected widget and a reduced display size of the reducible widgets among the remaining widgets.

For example, the external input may comprise a touch input to a portion other than an executable portion on the widget, a double tap input to the widget, a long press input to the widget, or a drag input from the widget.

As described above, the non-transitory computer readable storage medium may store one or more programs. The one or more programs may comprise instructions to, when executed by an electronic device comprising a display, cause the electronic device to display, through the display, a plurality of widgets. The one or more programs may comprise instructions to, when executed by the electronic device, cause the electronic device to, based on an external input or an event, select a widget among the plurality of widgets. The one or more programs may comprise instructions to, when executed by the electronic device, cause the electronic device to identify a changed display size for expanding a display size of the selected widget. The one or more programs may comprise instructions to, when executed by the electronic device, cause the electronic device to, based on the changed display size, identify a first area corresponding to a first blank area in the display for displaying the selected widget. The one or more programs may comprise instructions to, when executed by the electronic device, cause the electronic device to, if the selected widget with the changed display size is able to be displayed in the first area, display the selected widget in a second area including the first area. The one or more programs may comprise instructions to, when executed by the electronic device, cause the electronic device to, if the selected widget with the changed display size is not able to be displayed in the first area, display remaining widgets excluding the selected widget among the plurality of widgets by reducing a size of the remaining widgets, and display the selected widget with the changed display size in a third area corresponding to a second blank area caused by reducing the remaining widgets.

For example, the one or more programs may comprise instructions to, when executed by the electronic device, cause the electronic device to, based on a size of the second area that is greater than or equal to the changed display size of the selected widget, determine that the selected widget is able to be displayed in the first area as the changed display size. The one or more programs may comprise instructions to, when executed by the electronic device, cause the electronic device to, based on the size of the second area that is smaller than the changed display size of the selected widget, determine that the selected widget is not able to be displayed in the first area as the changed display size.

For example, the one or more programs may comprise instructions to, when executed by the electronic device, cause the electronic device to, based on a size of the third area that is greater than or equal to the changed display size of the selected widget, display the selected widget in the second area as the changed display size. The one or more programs may comprise instructions to, when executed by the electronic device, cause the electronic device to, based on the size of the third area that is smaller than the changed display size of the selected widget, display the selected widget as the changed display size by overlaying on the remaining widgets.

For example, the one or more programs may comprise instructions to, when executed by the electronic device, cause the electronic device to, if the selected widget is not able to be displayed in the first area as the changed display size, determine whether to change an arrangement of the remaining widgets while maintaining the size of the remaining widgets. The one or more programs may comprise instructions to, when executed by the electronic device, cause the electronic device to, based on determination to change the arrangement while maintaining the size of the remaining widgets, display the selected widget as the changed display size in a fourth area comprising a third blank area caused by changing the arrangement while maintaining the size of the remaining widgets. The one or more programs may comprise instructions to, when executed by the electronic device, cause the electronic device to, based on determination not to change the arrangement while maintaining the size of the remaining widgets, display the remaining widgets by reducing the size of the remaining widgets, and display the selected widget in the third area as the changed display size.

For example, the one or more programs may comprise instructions to, when executed by the electronic device, cause the electronic device to, based on a size of the fourth area that is greater than or equal to the changed display size of the selected widget, determine to change the arrangement while maintaining the size of the remaining widgets. The one or more programs may comprise instructions to, when executed by the electronic device, cause the electronic device to, based on the size of the fourth area that is smaller than the changed display size of the selected widget, determine not to change the arrangement while maintaining the size of the remaining widgets.

For example, the one or more programs may comprise instructions to, when executed by the electronic device, cause the electronic device to, if the selected widget is not able to be displayed in the first area as the changed display size, identify reducible widgets among the remaining widgets. The one or more programs may comprise instructions to, when executed by the electronic device, cause the electronic device to, based on the identification, compare the changed display size of the selected widget with the size of the third area, according to the changed display size of the selected widget and a reduced display size of the reducible widgets among the remaining widgets.

For example, the external input may comprise a touch input to a portion other than an executable portion on the widget, a double tap input to the widget, a long press input to the widget, or a drag input from the widget.

The effects that may be obtained from the present disclosure are not limited to those described above, and any other effects not mentioned herein will be clearly understood by those having ordinary knowledge in the art to which the present disclosure belongs.

What is claimed is:

1. An electronic device comprising:
memory, comprising one or more storage mediums, storing instructions;
a display; and
at least one processor comprising processing circuitry,
wherein the instructions, when executed by the at least one processor individually or collectively, cause the electronic device to:
display, through the display, a plurality of widgets,
based on an external input or an event, select a widget among the plurality of widgets,
identify a changed display size for expanding a display size of the selected widget,
based on the changed display size, identify a first area corresponding to a first blank area in the display for displaying the selected widget,
if the selected widget with the changed display size is able to be displayed in the first area, display the selected widget in a second area including the first area, and
if the selected widget with the changed display size is not able to be displayed in the first area, display remaining widgets excluding the selected widget among the plurality of widgets by reducing a size of the remaining widgets, and display the selected widget with the changed display size in a third area corresponding to a second blank area caused by reducing the remaining widgets.

2. The electronic device of claim 1, wherein the instructions, when executed by the at least one processor individually or collectively, cause the electronic device to:
based on a size of the second area that is greater than or equal to the changed display size of the selected widget, determine that the selected widget is able to be displayed in the first area as the changed display size, and
based on the size of the second area that is smaller than the changed display size of the selected widget, determine that the selected widget is not able to be displayed in the first area as the changed display size.

3. The electronic device of claim 1, wherein the instructions, when executed by the at least one processor individually or collectively, cause the electronic device to:
based on a size of the third area that is greater than or equal to the changed display size of the selected widget, display the selected widget in the second area as the changed display size, and
based on the size of the third area that is smaller than the changed display size of the selected widget, display the selected widget as the changed display size by overlaying on the remaining widgets.

4. The electronic device of claim 1, wherein the instructions, when executed by the at least one processor individually or collectively, cause the electronic device to:
if the selected widget is not able to be displayed in the first area as the changed display size, determine whether to change an arrangement of the remaining widgets while maintaining the size of the remaining widgets,
based on determination to change the arrangement while maintaining the size of the remaining widgets, display the selected widget as the changed display size in a fourth area comprising a third blank area caused by changing the arrangement while maintaining the size of the remaining widgets, and
based on determination not to change the arrangement while maintaining the size of the remaining widgets, display the remaining widgets by reducing the size of the remaining widgets, and display the selected widget in the third area as the changed display size.

5. The electronic device of claim 4, wherein the instructions, when executed by the at least one processor individually or collectively, cause the electronic device to:
based on a size of the fourth area that is greater than or equal to the changed display size of the selected widget, determine to change the arrangement while maintaining the size of the remaining widgets, and
based on the size of the fourth area that is smaller than the changed display size of the selected widget, determine not to change the arrangement while maintaining the size of the remaining widgets.

6. The electronic device of claim 3, wherein the instructions, when executed by the at least one processor individually or collectively, cause the electronic device to:
if the selected widget is not able to be displayed in the first area as the changed display size, identify reducible widgets among the remaining widgets, and
based on the identification, compare the changed display size of the selected widget with the size of the third area, according to the changed display size of the selected widget and a reduced display size of the reducible widgets among the remaining widgets.

7. The electronic device of claim 1, wherein the external input comprises a touch input to a portion other than an executable portion on the widget, a double tap input to the widget, a long press input to the widget, or a drag input from the widget.

8. A method executed in an electronic device comprising a display, the method comprising:
displaying, through the display, a plurality of widgets;
based on an external input or an event, selecting a widget among the plurality of widgets,
identifying a changed display size for expanding a display size of the selected widget;
based on the changed display size, identifying a first area corresponding to a first blank area in the display for displaying the selected widget;
if the selected widget with the changed display size is able to be displayed in the first area, displaying the selected widget in a second area including the first area; and
if the selected widget with the changed display size is not able to be displayed in the first area, displaying remaining widgets excluding the selected widget among the plurality of widgets by reducing a size of the remaining widgets, and displaying the selected widget with the changed display size in a third area corresponding to a second blank area caused by reducing the remaining widgets.

9. The method of claim 8, further comprising:
based on a size of the second area that is greater than or equal to the changed display size of the selected widget, determining that the selected widget is able to be displayed in the first area as the changed display size, and
based on the size of the second area that is smaller than the changed display size of the selected widget, determining that the selected widget is not able to be displayed in the first area as the changed display size.

10. The method of claim 8, further comprising:
based on a size of the third area that is greater than or equal to the changed display size of the selected widget, displaying the selected widget in the second area as the changed display size, and
based on the size of the third area that is smaller than the changed display size of the selected widget, displaying the selected widget as the changed display size by overlaying on the remaining widgets.

11. The method of claim 8, further comprising:
if the selected widget is not able to be displayed in the first area as the changed display size, determining whether to change an arrangement of the remaining widgets while maintaining the size of the remaining widgets,
based on determination to change the arrangement while maintaining the size of the remaining widgets, displaying the selected widget as the changed display size in a fourth area comprising a third blank area caused by changing the arrangement while maintaining the size of the remaining widgets, and
based on determination not to change the arrangement while maintaining the size of the remaining widgets, displaying the remaining widgets by reducing the size of the remaining widgets, and displaying the selected widget in the third area as the changed display size.

12. The method of claim 11, further comprising:
based on a size of the fourth area that is greater than or equal to the changed display size of the selected widget, determining to change the arrangement while maintaining the size of the remaining widgets, and
based on the size of the fourth area that is smaller than the changed display size of the selected widget, determining not to change the arrangement while maintaining the size of the remaining widgets.

13. The method of claim 10, further comprising:
if the selected widget is not able to be displayed in the first area as the changed display size, identifying reducible widgets among the remaining widgets, and
based on the identification, comparing the changed display size of the selected widget with the size of the third area, according to the changed display size of the selected widget and a reduced display size of the reducible widgets among the remaining widgets.

14. The method of claim 8, wherein the external input comprises:
a touch input to a portion other than an executable portion on the widget, a double tap input to the widget, a long press input to the widget, or a drag input from the widget.

15. A non-transitory computer readable storage medium storing one or more programs, the one or more programs comprise instructions to, when executed by an electronic device comprising a display, cause the electronic device to:
display, through the display, a plurality of widgets;
based on an external input or an event, select a widget among the plurality of widgets;
identify a changed display size changed for expanding a display size of the selected widget;
based on the changed display size, identify a first area corresponding to a first blank area in the display for displaying the selected widget;
if the selected widget with the changed display size is able to be displayed in the first area, display the selected widget in a second area including the first area; and
if the selected widget with the changed display size is not able to be displayed in the first area, display remaining widgets excluding the selected widget among the plurality of widgets by reducing a size of the remaining widgets, and display the selected widget with the changed display size in a third area corresponding to a second blank area caused by reducing the remaining widgets.

16. The non-transitory computer readable storage medium of claim 15, wherein the one or more programs comprise the instructions to, when executed by the electronic device, cause the electronic device to:
based on a size of the second area that is greater than or equal to the changed display size of the selected widget, determine that the selected widget is able to be displayed in the first area as the changed display size, and
based on the size of the second area that is smaller than the changed display size of the selected widget, determine that the selected widget is not able to be displayed in the first area as the changed display size.

17. The non-transitory computer readable storage medium of claim 15, wherein the one or more programs comprise the instructions to, when executed by the electronic device, cause the electronic device to:
based on a size of the third area that is greater than or equal to the changed display size of the selected widget, display the selected widget in the second area as the changed display size, and
based on the size of the third area that is smaller than the changed display size of the selected widget, display the selected widget as the changed display size by overlaying on the remaining widgets.

18. The non-transitory computer readable storage medium of claim 15, wherein the one or more programs comprise the instructions to, when executed by the electronic device, cause the electronic device to:
if the selected widget is not able to be displayed in the first area as the changed display size, determine whether to change an arrangement of the remaining widgets while maintaining the size of the remaining widgets,
based on determination to change the arrangement while maintaining the size of the remaining widgets, display the selected widget as the changed display size in a fourth area comprising a third blank area caused by changing the arrangement while maintaining the size of the remaining widgets, and
based on determination not to change the arrangement while maintaining the size of the remaining widgets, display the remaining widgets by reducing the size of the remaining widgets, and display the selected widget in the third area as the changed display size.

19. The non-transitory computer readable storage medium of claim 18, wherein the one or more programs comprise the instructions to, when executed by the electronic device, cause the electronic device to:
based on a size of the fourth area that is greater than or equal to the changed display size of the selected widget, determine to change the arrangement while maintaining the size of the remaining widgets, and
based on the size of the fourth area that is smaller than the changed display size of the selected widget, determine not to change the arrangement while maintaining the size of the remaining widgets.

20. The non-transitory computer readable storage medium of claim 17, wherein the one or more programs comprise the instructions to, when executed by the electronic device, cause the electronic device to:
if the selected widget is not able to be displayed in the first area as the changed display size, identify reducible widgets among the remaining widgets, and
based on the identification, compare the changed display size of the selected widget with the size of the third area, according to the changed display size of the selected widget and a reduced display size of the reducible widgets among the remaining widgets.
